(19) United States
(12) Patent Application Publication
(10) Pub. No.: US 2002/0032022 A1
(43) Pub. Date: Mar. 14, 2002

(54) Mobile telephone device and a method for rewriting software used therein

(75) Inventor: Ichiro Ozaki, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/952,169

(22) Filed: Sep. 13, 2001

(30) Foreign Application Priority Data
Sep. 13, 2000 (JP) 277411/2000

(51) Int. Cl. H04M 3/00

(52) U.S. Cl. 455/418; 455/419; 455/425

(57) ABSTRACT

The control portion operates to read out information stored in the main program storage device 5, to process information input from a wireless transmission 1 and a wired transmission portion 6 and to control a user interface 4, thereby realizing all the functions of the mobile telephone device. When the information input from the wireless portion 1 or the wired portion 6 is a program component, the control portion 2 rewrites that to the rewritable area 5a maintained in a main program storage device 5.

### BACKGROUND OF THE INVENTION

1. Field of the Invention

The present invention relates to a mobile telephone device and a method for rewriting software used therein as well as a storage medium for storing the control program, and more specifically concerning the method for rewriting the software stored inside the mobile telephone device.

2. Description of Related Art

As illustrated in FIG. 5 a conventional mobile telephone device consists of a wireless portion 11, a control portion 12, a user operating portion 13, a user interface 14, a main program storage device 15, a wired transmission portion 16 and a temporary storage device 17.

The wireless portion 11 sends and receives wireless signals. The wired transmission portion 16 performs input and output through wiring, to an external device not shown in the drawings. The control portion 12 operates to read out information stored in the main program storage device 15, and processes information input from the wireless portion 11, the wired transmission portion 16 and the user operating portion 13 respectively.

Notification of the results of the processing performed by the control portion 12 is provided to the user through the user interface 14 as either audio or visual display information. The temporary storage device 17 is used mainly as a working area when the control portion 12 is working.

However a problem with conventional mobile telephone devices as described above is that because it is taken that it should not be possible after delivery for rewriting to occur in the main program storage device, in other words, because there is no storage area that is available for rewriting after delivery, it is very difficult to rewrite the contents after delivery.

Further, because these conventional devices are not designed premised on having capabilities for rewriting programs stored in the main program storage device, the problem arises that in order to just modify a specific functionality only, it is necessary to rewrite all of the program and that requires a lot of work in development and maintenance.

### SUMMARY OF THE INVENTION

It is an object of the present invention to solve the above problems by providing a mobile telephone device for which it is possible to make a quick response making changes or repairs if it becomes necessary to change specifications or a defect is discovered after delivery, by providing a method for rewriting internal software and by providing a storage medium for storing a control program.

A mobile telephone device of the present invention is a mobile telephone device capable of receiving data via a wired or wireless portion, and wherein a substitutable program component received via the wired or wireless portion can be introduced as a new program, with the existing program being rendered inoperable.

A method for rewriting software of a mobile telephone device according to the present invention is a method for rewriting software of a mobile telephone device capable of receiving data via a wired or wireless portion, that enables a substitutable program component received via the wired or wireless portion to be introduced as a new program, with the existing program being rendered inoperable.

Thus, for a mobile telephone device of the present invention wherein a substitutable program component received via the wired or wireless portion can be introduced as a new program with the existing program rendered inoperable, it becomes possible to provide a flexible response to change specifications or repair a problem and changes and repairs can be performed efficiently.

More specifically, a mobile telephone device of the present invention is formed so that, when the information input from the wired or wireless portion is a program component, the control portion rewrites the contents of a rewritable area maintained inside the main program storage device with the program component.

The wireless portion sends and receives wireless signals and the portion for wired transmission inputs and outputs to an external device via wire. The control portion operates to read out information stored in the main program storage device, to process information input from the portion for wireless transmission, the portion for wired transmission and from the user control portion and to control the user interface, thereby realizing all the functions of the mobile telephone device.

In accordance with the above, it becomes possible to rewrite (or patch) part of a program of a mobile telephone device after it is delivered, so that even if after delivery, there are partial changes to the specifications of a service provided over a network or a defect is discovered, the required specification changes or repairs to the defect can be performed efficiently.

### BRIEF DESCRIPTION OF THE DRAWINGS

Specific embodiments of the present invention will now be described, by way of example only, with reference to the accompanying of drawings in which:

FIG. 1 is a block diagram showing the structure of a mobile telephone device according to the form of the embodiments of the present invention;

FIG. 2 is a block diagram showing the structure of a mobile telephone device according to an embodiment of the present invention;

FIG. 3 is a flowchart showing the operations of a mobile telephone device according to an embodiment of the present invention;

FIG. 4 is a drawing showing an example of the structure of the main program storage device shown in FIG. 2 ; and

FIG. 5 is a block diagram showing the structure of a conventional mobile telephone device.

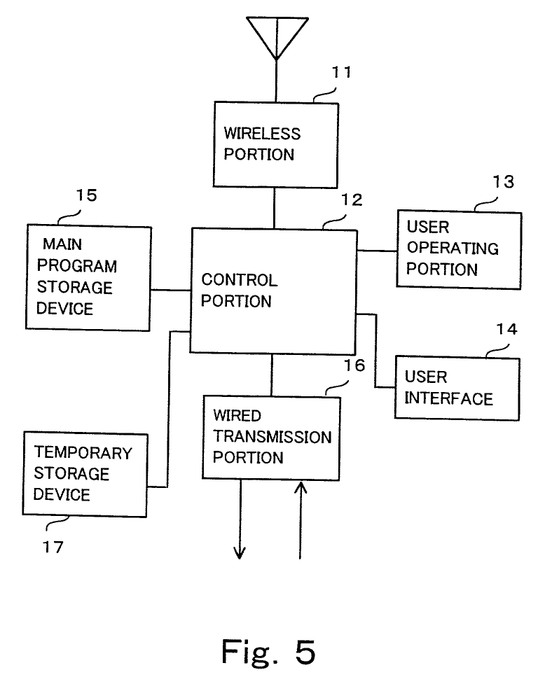

### DETAILED DESCRIPTION OF THE PREFERRED EMBODIMENTS

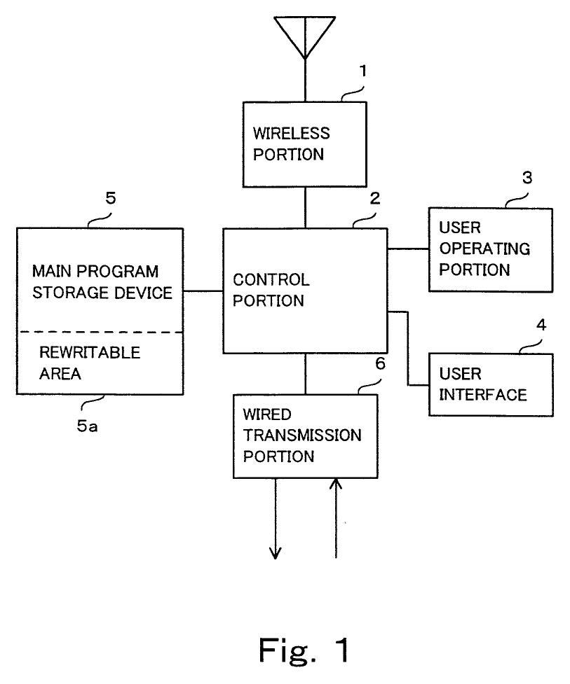

Referring to FIG. 1, a mobile telephone device of the form of the embodiments of the present invention consists of a wireless portion 1, a control portion 2, a user operating portion 3, a user interface 4, a main program storage device 5 and a wired transmission portion 6.

The wireless portion 1 sends and receives wireless signals. The wired transmission portion 6 performs input and output through wiring to an external device not shown in the drawings. The control portion 2 operates to read out information stored in the main program storage device 5, process information input from the wireless portion 1, the wired transmission portion 6 and the user operating portion 3 respectively and to control the user interface 4, thereby realizing all of the functions of the mobile telephone device.

When the information input from the wired or wireless portion is a program component, the control portion 2 rewrites the contents of a rewritable area 5a maintained inside the main program storage device 5 with the program component.

In accordance with the above, rewriting (or making a patch for) part of a program of the mobile telephone device after it is delivered, means that even if there are partial changes to the specifications of a service provided over a network or a defect is discovered after delivery, the required specification changes or repairs to the defect can be performed efficiently.

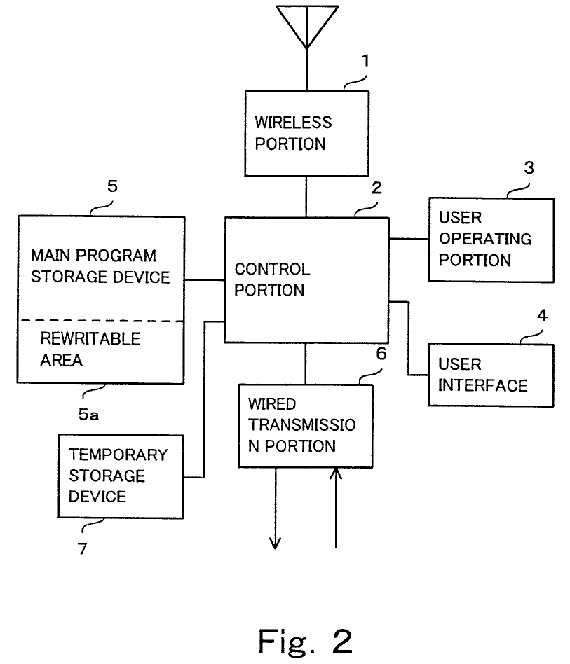

Referring to FIG. 2, a mobile telephone device according to an embodiment of the present invention comprises a wireless portion 1, a control portion 2, a user operating portion 3, a user interface 4, a main program storage device 5, a wired transmission portion 6 and a temporary storage device 7.

The wireless portion 1 sends and receives wireless signals. The wired transmission portion 6 performs input and output through wiring, to an external device not shown in the drawings. The control portion 2 operates to read out information stored in the main program storage device 5, and processes information input from the wireless portion 1, the wired transmission portion 6 and the user operating portion 3 respectively. Notification of the results of the processing performed by the control portion 2 is provided to the user through the user interface 4 as either audio or visual display information.

Temporary storage device 7 is used mainly when the control portion 2 is operating for a working area, and part of temporary storage device 7 is used for temporarily housing any program component received from the wireless portion 1 or the wired portion 6. Once a program component is stored in the temporary storage device 7 substitution processes are executed for the program and the program component is written into a rewritable area 5a maintained inside the main program storage device 5.

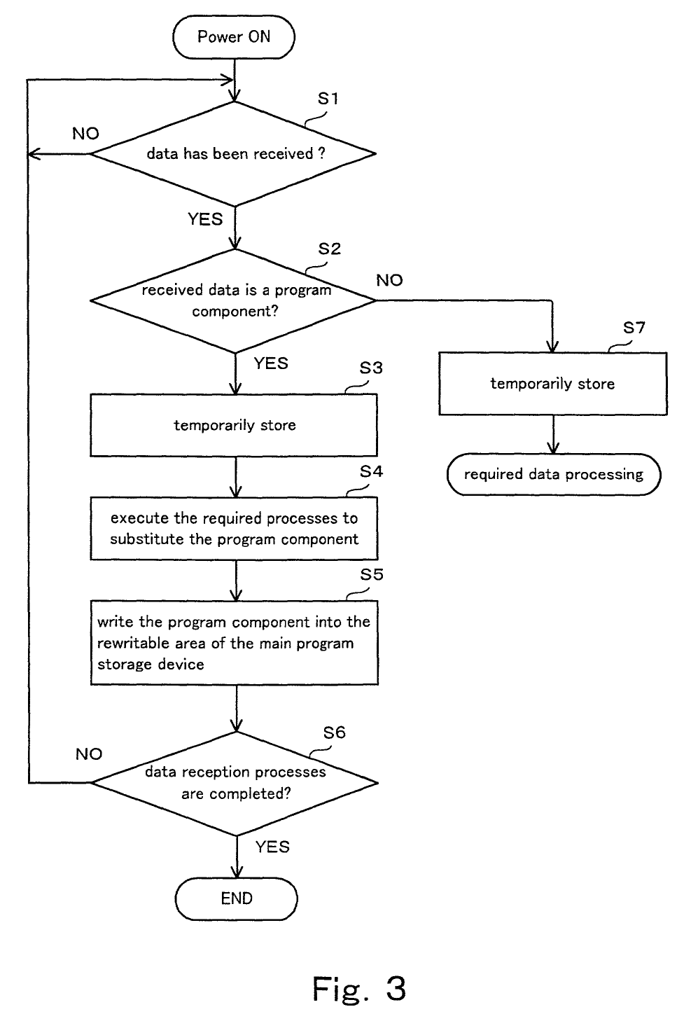

The workings of a mobile telephone device according to an embodiment of the present invention will now be described with reference to FIGS. 2 and 3. In respect of the processing operations shown in FIG. 3, the explanation of the operation of the outgoing and incoming calls of the mobile telephone device has been dispensed with. The processing operations described in FIG. 3 occur as the control portion 2 executes the program in the main program storage device 5, however it is also possible for the program to be stored in a storage medium besides the main program storage device 5.

As a power source (not shown in the drawings) is turned on, the control portion 2 executes a decision on whether or not data has been received by the wireless portion 1 or the wired transmission portion 6 (S1) and if no data has been received, the control portion goes on standby.

When data is received the control portion 2 decides whether that data is a program component or not (S2) and if the data received is not a program component, after that data is temporarily stored in the temporary storage device 7 (S7), the control portion 2 performs the required types of data processing operations on that received data. To facilitate the decision on whether or not received data is a program component, processes to add identification information to the header of the received data should be performed to specify that that data is a program component.

If the data received is a program component, the control portion 2 temporarily stores the program component in the temporary storage device 7 (S3), executes the required processes to substitute the program component over another program as required (S4) and writes the program component into the rewritable area 5 of the main program storage device 5 (S5).

If the data reception processes are completed (S6), the control portion 2 discontinues the data reception processing described above but if the data reception processes are not completed (S6), the control portion 2 returns back to Step S1 and repeats the above data reception processes over again.

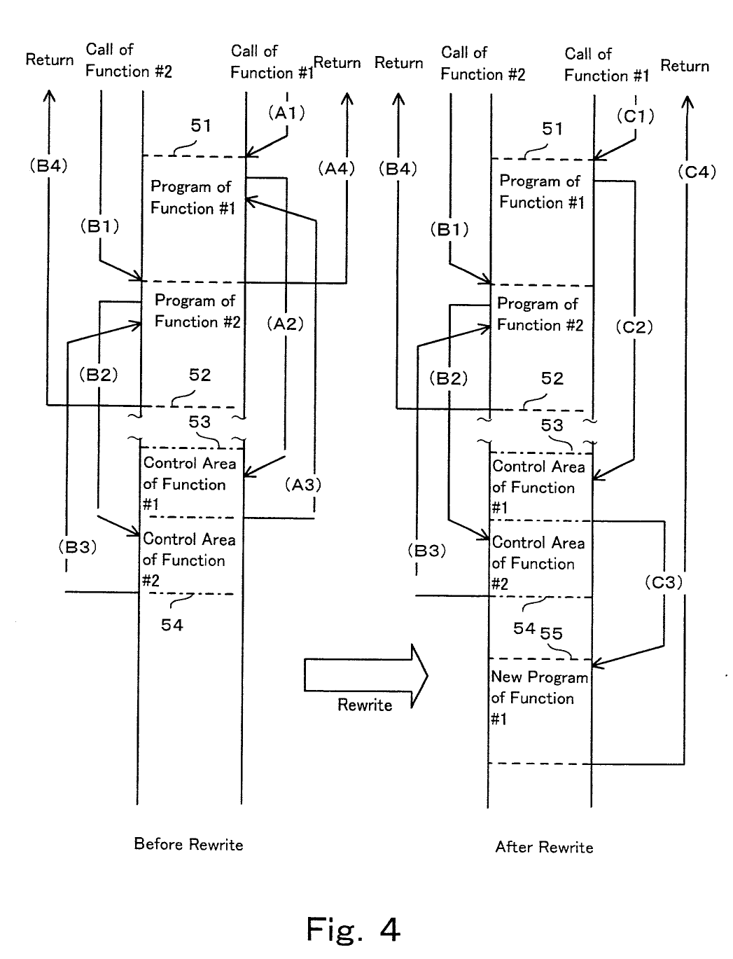

Referring to FIG. 4, because a function #1 of a program 51 and a function #2 of a program 52 are not included in the rewritable area 5a of the program storage device 5, no changes are made before or after the rewriting.

A mobile telephone device according to the present invention is designed to work so that the control portion initiates a jump from the head of the program 51 of the function #1 to a control area 53 for the function #1 and from the head of the program 52 of the function #2 to a control area 54 for the function #2. The design is such that the control portion then initiates a jump from the control area 53 of the function #1 back to the original program, the area of the program 51 of the function #1 and from the control area 54 of the function #2 back to the original program, the area of the program 52 of the function #2.

To rewrite the program 51 of the function #1, the control portion updates the control area 53 for the function #1 inside the rewritable area 5a reallocating that control area for a new program 55 of the function #1 and writes the new program 55 of the function #1 into the rewritable area 5a. Even after the new program 55 is written in, the program 51 of the function #1 remains stored in the main program storage device 5 so that if an error occurs in the rewriting operation the program 51 can be restored easily. The above description illustrating how the control portion updates the control area 53 for the function #1 and allocates a new program 55 of function 1 therein, shows how a program component is substituted over another program as described above.

The procedures both before and after the execution of rewriting operations in the rewritable area 5a of the main program storage device 5 will now be described with reference to FIG. 4. Before the rewriting operation is initiated, the control portion requests the function #1 (A1), and immediately after the program 51 of the function #1 is executed the control portion initiates a jump to the control area 53 of the function #1 (A2).

The control portion is programmed to reallocate the control area 53 of the function #1 back to the program 51 of the function #1 and recover the program 51 of the function #1 immediately (A3). Thereafter, the program 51 of the function #1 is executed at which point the control returns back to the function that requested the function #1. (A4). The same procedures are implemented when the function #2 is requested. (B1 to B4).

When the function #1 is requested (C1), the control portion initiates a jump to the control area 53 for the function #1 immediately after execution of the program 51 of the function #1 commences (C2), and is programmed to allocate the control area 53 of the function #1 over to the new program 55 of the function #1 (C3). The new program 55 of the function #1 is executed and the functions of the function #1 are recovered at the point at which that execution is completed (C4). The procedures for execution of function #2 however {do not implement rewriting of data and so conditions remain unchanged.

Because the wireless portion 1, the control portion 2, the user operating portion 3, the user interface 4, the wired transmission portion 6 and the temporary storage device 7 will be well known to those skilled in the art and because they do not have any direct bearing on the present invention, a detailed description of their structure or workings is not provided in the above description.

A mobile telephone device according to the present invention as described above is a device for which changes to specific functions can easily be made to cater for specific specification changes occurring after delivery, thereby allowing for a flexible response to coordinate with a service provided by a transmission service provider or with a new service commenced after delivery.

The program that provides the functions resident in a mobile telephone device of the present invention is not firmware but is handled instead as software which decreases the workload required to develop fixes for specific functions only and reduces the time required for such development work.

The present invention as described above is a mobile telephone device capable of receiving data via a wired or wireless means, wherein a substitutable program component received via the wired or wireless means can be introduced as a new program with the existing program being rendered inoperable, so that even if there are specifications changes or a defect is discovered after delivery the required changes or repairs can be promptly implemented.

What is claimed is:

1. A mobile telephone device capable of receiving data via a wired or wireless means, wherein a substitutable program component received via the wired or wireless means can be introduced as a new program, with the existing program being rendered inoperable.

2. A mobile telephone device according to claim 1 provided with a main storage device for recording programs and a rewritable area that independently handles the program contents to be rewritten, which device comprises a means for deciding whether or not the data received via said wired or wireless means is a said substitutable program component, and a means that, when said means for deciding decides that said received data is a program component, acts to rewrite said program component into said rewritable area.

3. A mobile telephone device according to claim 2 comprising a means that responds to a request for a program in said main storage device {which program is} to be rewritten, at times when said means for rewriting is going to rewrite into said rewritable area and implements substitution processes for requesting a program for said rewritable area.

4. A method for rewriting software of a mobile telephone device which device is capable of receiving data via a wired or wireless means, which method introduces a substitutable program component received via the wired or wireless means as a new software program, and renders the existing program inoperable.

5. A method for rewriting software according to claim 4 which includes steps for deciding whether or not data received via said wired or wireless means is a program component, and for writing the data decided being a program component into a rewritable area within a main storage device which stores programs.

6. A method for rewriting software according to claim 5 which includes a step for responding to a request for a program of said main storage device to be rewritten, at times when a rewriting operation to said rewritable area will be performed and implements substitution processes for requesting a program for said rewritable area.
